(19) United States
(12) Patent Application Publication
(10) Pub. No.: US 2026/0052585 A1
(43) Pub. Date: Feb. 19, 2026

(54) Enhanced In-Device Coexistence Reporting in Wireless Communication Systems

(71) Applicant: Apple Inc., Cupertino, CA (US)

(72) Inventors: Yuqin Chen, Beijing (CN); Haijing Hu, Los Gatos, CA (US); Naveen Kumar R Palle Venkata, San Diego, CA (US); Pavan Nuggehalli, San Carlos, CA (US); Fangli Xu, Beijing (CN); Ralf Rossbach, Munich (DE); Alexander Sirotkin, Hod Hasharon (IL); Zhibin Wu, Los Altos, CA (US); Dawei Zhang, Saratoga, CA (US); Sethuraman Gurumoorthy, San Ramon, CA (US)

(21) Appl. No.: 19/101,065

(22) PCT Filed: Aug. 9, 2022
(86) PCT No.: PCT/CN2022/111194

§ 371 Date: Feb. 4, 2025

(51) Int. Cl. H04W 76/10; H04W 76/27

(52) U.S. Cl. CPC H04W 76/10; H04W 76/27

(57) ABSTRACT

A user equipment (UE) may establish a radio resource control (RRC) connection with a network node and receive a RRC reconfiguration message from the network node. The UE may determine, based on the RRC reconfiguration message, at least one of one or more clean resources or one or more non-clean resources, wherein the one or more non-clean resources may correspond to at least one in-device coexistence (IDC) conflict. The UE may transmit uplink assistance information (UAI) to the network node and the UAI may include information corresponding to one or more starting points and one or more ending points of at least one of the one or more clean resources or one or more non-clean resources.

### FIELD

The present application relates to wireless devices, and more particularly to apparatuses, systems, and methods for enhanced In-Device Coexistence (IDC) reporting in wireless communication systems.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including fifth generation (5G) new radio (NR) communication. Accordingly, improvements in the field in support of such development and design are desired.

### SUMMARY

Embodiments relate to apparatuses, systems, and methods for enhanced in-device coexistence (IDC) reporting in wireless communication systems.

In some embodiments, a user equipment (UE) may establish a radio resource control (RRC) connection with a network node and receive a RRC reconfiguration message from the network node. The UE may determine, based on the RRC reconfiguration message, at least one of one or more clean resources or one or more non-clean resources, wherein the one or more non-clean resources may correspond to at least one in-device coexistence (IDC) conflict. The UE may transmit uplink assistance information (UAI) to the network node and the UAI may include information corresponding to one or more starting points and one or more ending points of at least one of the one or more clean resources or one or more non-clean resources.

According to some embodiments, the information may include one or more resource numbers of the one or more clean resources and the one or more non-clean resources. In some embodiments, at least one of the one or more starting points or one or more ending points may be reported by the UE in relation to at least one of a lower edge of a component carrier (CC) or an absolute radio frequency channel number (ARFCN). Additionally or alternatively, the one or more clean resources and one or more non-clean resources may be at least one of one or more bandwidth parts (BWPs) or one or more physical resource blocks (PRBs). According to further embodiments, the RRC reconfiguration message may include configuration information corresponding to at least one of carrier aggregation, dual-connectivity, one or more BWPs, or an absolute radio frequency channel number (ARFCN) configured by the network node.

In some embodiments, the network node may be a master node (MN) corresponding to a first radio access technology (RAT) wherein the UAI may be transmitted to at least one of the MN or a secondary node (SN) corresponding to the first RAT.

According to further embodiments, the UE may receive, from the network node, configuration information corresponding to an IDC reporting prohibit timer. Additionally or alternatively, the UE may start the IDC reporting prohibit timer after transmitting the UAI, wherein the UE may be prohibited from transmitting additional UAI while the IDC reporting prohibit timer is running, according to some embodiments.

In some embodiments, a network node may establish a radio resource control (RRC) connection with a user equipment (UE) and transmitting, to the UE, a RRC reconfiguration message. The network node may then receive, from the UE, uplink assistance information (UAI). Additionally or alternatively, the UAI may include information corresponding to at least one of one or more clean resources or one or more non-clean resources associated with one or more component carriers (CCs). Furthermore, the one or more non-clean resources correspond to at least one in-device coexistence (IDC) conflict, according to some embodiments. The network node may then restrict, based on the UAI, usage of the one or more non-clean resources.

According to some embodiments, restricting usage of the one or more non-clean resources may include releasing one or more of the non-clean resources. Additionally or alternatively, restricting usage of the one or more non-clean resources may include releasing a secondary cell (SCell) on one of the one or more CCs. In some embodiments, restricting usage of the one or more non-clean resources may include at least one of performing scheduling based on a hybrid automatic repeat request pattern, configuring the UE to utilize a time domain multiplexing (TDM) pattern, or configuring the UE to utilize a discontinuous reception (DRX) configuration.

In some embodiments, the network node may receive, from a secondary node (SN), a secondary cell group (SCG) configuration for carrier aggregation (CA) and forward the UAI to the SN. Additionally, the network node may be configured to transmit, to the UE, configuration information corresponding to an IDC reporting prohibit timer in which the UE may be prohibited from transmitting additional UAI while the IDC reporting prohibit timer is running, according to some embodiments. In some embodiments, the UAI may be received via media access control-control element (MAC-CE) signaling.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system, according to some embodiments;

FIG. 2 illustrates a base station (BS) in communication with a user equipment (UE) device, according to some embodiments;

FIG. 3 illustrates an example block diagram of a UE, according to some embodiments;

FIG. 4 illustrates an example block diagram of a BS, according to some embodiments;

FIG. 5 illustrates an example block diagram of cellular communication circuitry, according to some embodiments;

FIG. 6 is an example block diagram illustrating aspects of uplink carrier aggregation through utilization of two carriers, according to some embodiments;

FIG. 7 is a communication flow diagram illustrating aspects of an example method for enhanced in-device coexistence reporting;

FIGS. 8A-8C illustrate various aspects and methods for enhanced IDC reporting using frequency division multiplexing (FDM), according to some embodiments;

FIGS. 9A-9D illustrate various aspects and methods for enhanced IDC reporting using FDM in single carrier and carrier aggregation scenarios, according to some embodiments;

FIG. 10 illustrates various aspects for enhanced IDC reporting for multi-radio access technology-dual connectivity (MR-DC), according to some embodiments; and

FIGS. 11-12 illustrate various aspects of enhanced IDC reporting using medium access control-control element (MAC-CE) reporting, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
TS: Technical Specification
RAN: Radio Access Network
RAT: Radio Access Technology
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC: 5G Core Network
CA: Carrier Aggregation
FR: Frequency Range
PCC: Primary Component Carrier
SCC: Secondary Component Carrier
LB: Low Band
MB: Mid Band
HB: High Band
UHB: Ultra-High Band
TRP: Total Radiated Power
RSRP: Reference Signal Received Power
PUCCH: Physical Uplink Control Channel
RACH: Random Access Channel
BW: Bandwidth
TX: Transmit/Transmission
RX: Receive/Reception
IDC: In-Device Coexistence
IDM: Interleave Division Multiplexing
LAA: Licensed Assisted Access
ISM: Industrial, Scientific, and Medical Radio Band
GNSS: Global Navigation Satellite System
IMD: Intermodulation
WLAN: Wireless Local Area Network
FDM: Frequency Division Multiplexing
TDM: Time Division Multiplexing
RRC: Radio Resource Control
DRX: Discontinuous Reception
HARQ: Hybrid Automatic Repeat Request
PHR: Power Headroom
HO: Handover
BT: Bluetooth
E-UTRAN: Evolved-Universal Terrestrial Radio Access Network
EN-DC: E-UTRAN New Radio-Dual Connectivity
MR-DC: Multi-RAT-Dual Connectivity
NR-DC: New Radio-Dual Connectivity
BWP: Bandwidth Part
PRB: Physical Resource Block
ARFCN: Absolute Radio Frequency Channel Number
UAI: Uplink Assistance Information
MN: Master Node
MCG: Master Cell Group
SN: Secondary Node
SCG: Secondary Cell Group
CG: Cell Group
CC: Component Carrier
SCell: Secondary Cell
MAC-CE: Medium Access Control-Control Element

### Terms

The following is a glossary of terms used in this disclosure:

Memory Medium-Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium-a memory medium as described above, as well as a physical transmission medium, such as a bus, network, and/or other physical transmission medium that conveys signals such as electrical, electromagnetic, or digital signals.

Programmable Hardware Element-includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System-any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device-any of various types of computer systems or devices that perform wireless communications. A wireless device can be portable (or mobile) or may be stationary or fixed at a certain location. A UE is an example of a wireless device.

Communication Device-any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

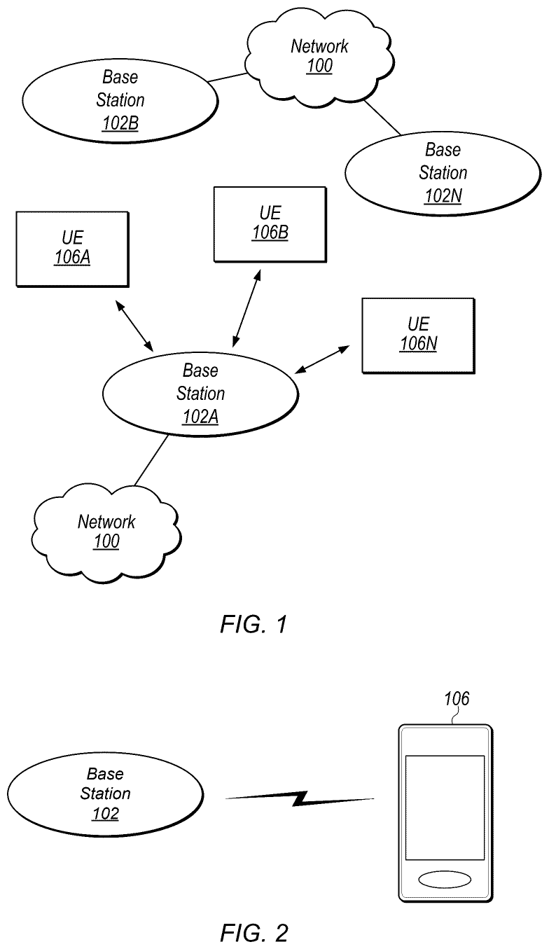

### FIGS. 1 and 2—Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”), and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, CHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPoints). In addition, a UE capable of operating according to 5G NR may be connected to one or more TRPoints within one or more gNBs. For example, it may be possible that that the base station 102A and one or more other base stations 102 support joint transmission, such that UE 106 may be able to receive transmissions from multiple base stations (and/or multiple TRPoints provided by the same base station).

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, cHRPD), etc.). The UE 106 may also or alternatively be configured to communicate using one or more global navigational satellite systems (GNSS, e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer, a laptop, a tablet, a smart watch or other wearable device, or virtually any type of wireless device.

The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, NR or LTE using at least some shared radio components. As additional possibilities, the UE 106 could be configured to communicate using CDMA2000 (1×RTT/1×EV-DO/HRPD/cHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

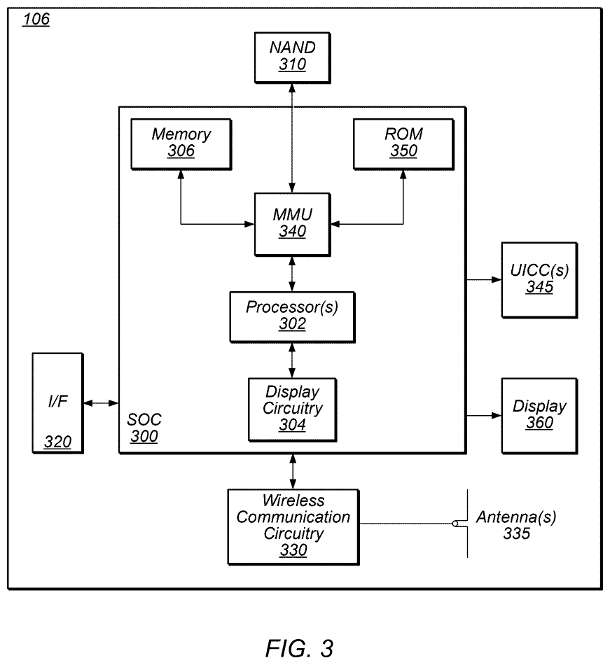

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, etc.). In some embodiments, communication device 106 may include wired communication circuitry (not shown), such as a network interface card, e.g., for Ethernet.

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include one or more receive chains (including and/or coupled to (e.g., communicatively; directly or indirectly) dedicated processors and/or radios) for multiple RATs (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with a second radio. The second radio may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, etc.) configured to perform the functions of wireless communication circuitry 330.

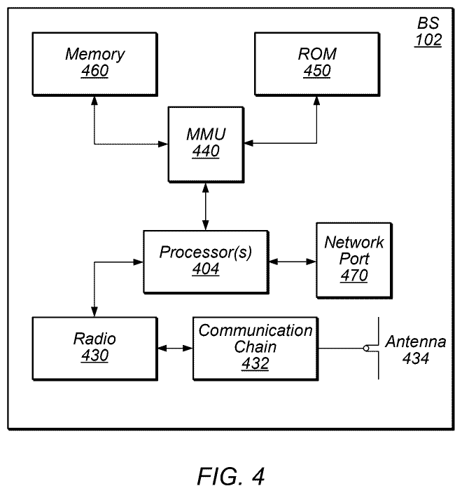

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPoints). In addition, a UE capable of operating according to 5G NR may be connected to one or more TRPoints within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

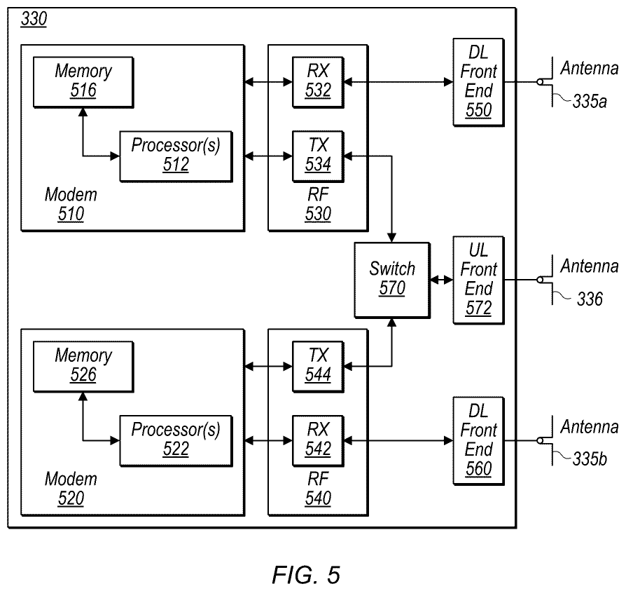

### FIG. 5—Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some embodiments, the cellular communication circuitry 330 may also not include the switch 570, and the RF front end 530 or the RF front end 540 may be in communication, e.g., directly, with the UL front end 572.

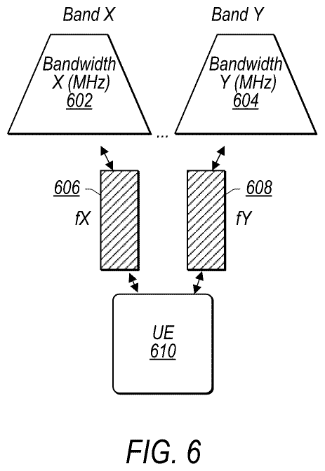

### FIG. 6—Carrier Aggregation

FIG. 6 is an example block diagram illustrating aspects of carrier aggregation (CA), according to some embodiments. More specifically, FIG. 6 illustrates the principle of uplink carrier aggregation (UL-CA) where a UE 610 may be configured to transmit simultaneously on two contiguous or non-contiguous carriers. Moreover, it may be possible for the UE to use the same antenna port or multiple antenna ports (e.g., antenna(s)) to transmit on the multiple uplink carriers.

For example, FIG. 6 illustrates two carriers (e.g., X and Y) corresponding to certain channel bandwidths (e.g, Bandwidth X 602 and Bandwidth Y 604) associated with their respective bands (e.g., Band X and Band Y). Furthermore, FIG. 6 illustrates that a UE 610 may be able to transmit simultaneously on the two carriers using two different frequencies fX 606 and fY 608. In some embodiments, Band X and Band Y may be contiguous such that their frequency bands share a common or neighboring frequency border (e.g., the frequency bands lie next to one another such as Long Term Evolution (LTE) Band 13 and LTE Band 14). Additionally or alternatively, the two bands may be non-contiguous (e.g., LTE Band 2 and LTE Band 13) corresponding to frequency bands with one or more frequency gaps in between them. Contiguous and non-contiguous new radio (NR) bands may similarly be used for uplink carrier aggregation.

In some embodiments, Bandwidth X 602 and Bandwidth Y 604 may be similar or the same bandwidths. For example, Bandwidth X 602 and Bandwidth Y 604 may each correspond to a bandwidth of 20 MHz. Additionally or alternatively, Bandwidth X 602 and Bandwidth Y 604 may be characterized by a variety of different channel bandwidths. For example, Bandwidth X 602 may be a 20 MHz bandwidth while Bandwidth Y 604 may characterized by a bandwidth of 10 MHZ, according to some embodiments. According to further embodiments, a UE 610 may utilize frequency fX 606 to communicate using Bandwidth X 602 corresponding to Band X. Additionally or alternatively, the UE 610 may also use frequency fY 608 to communicate using a channel bandwidth such as Bandwidth Y 604 corresponding to Band Y. While some of the embodiments described above utilize examples of LTE Bands and their corresponding frequencies and bandwidths (among other characteristics), FIG. 6 could also describe scenarios of UL-CA utilizing various examples of New Radio (NR) bands and their corresponding frequencies and channel bandwidths (among other characteristics).

In some legacy systems, user equipment (UE) may not have been configured or designed to support transmission (Tx) operations on the same antenna port or multiple antenna ports to transmit on multiple uplink carriers for inter-band UL-CA. For example, the selection of the antenna ports for inter-band UL-CA may be based on the receive (Rx) monitoring for Primary Component Carrier 1 (PCC1) and PCC2. More specifically, the receive monitoring may have involved monitoring two Rx antenna ports (e.g., antennas) for low band (LB) and 4 Rx antenna ports for mid band (MB), high band (HB), or ultra-high band (UHB). In some embodiments, LB may correspond to frequencies less than or equal to 1 GHZ, MB may correspond to frequencies between 1 and 2 GHz, HB may correspond to frequencies between 2 and 3 GHZ and UHB may correspond to frequencies between 3 and 6 GHZ.

As one example, inter-band UL-CA for LTE Band 12 and LTE Band 2 may use two separate antenna ports (e.g., antennas) for Tx transmission. Furthermore, these two separate Tx ports may be selected based on downlink Rx measurements such as reference signal received power (RSRP). Additionally, while some of the embodiments described above utilize examples of UL-CA, FIG. 6 could also describe scenarios of downlink (DL-CA) (e.g., the UE receiving transmissions from the network) utilizing various examples of NR or LTE bands and their corresponding frequencies and channel bandwidths (among other characteristics). However, issues may arise due to the antennas or antenna ports being located in proximity to one another. More specifically, coexistence (e.g., in-device coexistence (IDC)) interference may occur across a number of antennas within the same UE.

For example, a UE may have three antennas (ANT #1, ANT #2, and ANT #3) corresponding to various frequencies and ANT #1 may be associated with LTE radio frequency (RF) and LTE baseband frequencies, ANT #2 may be associated with GPS RF and GPS baseband frequencies, and ANT #3 may be associated with Bluetooth (BT) or WiFi RF and BT/WiFi baseband frequencies. Accordingly, the transmissions and receptions of these antennas and various bands may result in interference across the different antennas. For example, ANT #1 may cause interference from LTE on ANT #2 and ANT #3. Additionally or alternatively, ANT #3 may cause interference from BT/WiFi on ANT #1, according to some scenarios. Accordingly, coexistence interference involving the LTE radio may be interfered by the Industrial, Scientific, and Medical (ISM) radio band due to reception on the LTE antenna and transmission on the BT/WiFi antenna. Additionally or alternatively, transmission on the LTE antenna and reception on the BT/WiFi antenna may cause result in coexistence interference involving the ISM radio being interfered by LTE.

In another scenario, coexistence interference may occur between an in-device ISM transmitter and an Evolved-Universal Terrestrial Radio Access (E-UTRA) receiver. For example, coexistence interference involving the Global Navigation Satellite System (GNSS) radio being interfered by the LTE antenna due to transmission on the LTE antenna and reception on the GNSS antenna. Additionally or alternatively, if both the LTE and GNSS antennas are receiving rather than transmitting, there may be no interference issues.

In other words, there may be various forms of interference including inter-radio access technology (RAT) harmonic or interleave division multiplexing (IDM) interference due to the Tx and Rx of the different antennas. For example, interference of LTE to or from ISM and LTE to GNSS. Additionally or alternatively, there may exist interference including LTE UL CA IMD interference to wireless local area network (WLAN), BT, and GNSS. Moreover, interference scenarios may include NR only harmonic or LTE+NR (EN-DC) UL IMD interference to WLAN, Bluetooth and GNSS in EN-DC. In some scenarios, hardware sharing between WiFi and Licensed Assisted Access (LAA) may also result in interference issues.

Accordingly, these issues could result in a degraded cellular performance especially in scenarios in which transmission power is limited due to Tx backoff (e.g., backing off/lowering the transmit power) or limited overhead/power headroom (PHR). For example, the higher frequency bands MB/HB/UHB may utilize higher Tx backoff values as compared to LB. These transmission power backoff values may be characterized or utilized as such to help mitigate distortions associated with the transmissions (e.g., intermodulation or harmonic distortions, etc.). Additionally or alternatively, current network implementation signaling may only be supported on PCC1 for both the carriers. This could also result in degraded signaling performance if the MB/HB/UHB carrier is assigned to PCC1 which has high Tx backoff.

One objective that may be targeted in cellular communication technology developments, potentially including in 3GPP cellular technologies such as LTE and NR, may include reducing or mitigating interference in IDC scenarios. New cellular communication techniques are continually under development, to increase coverage, to better serve the range of demands and use cases, and for a variety of other reasons. Therefore, it may be beneficial to provide for enhanced methods of UE IDC reporting so as to avoid potential interference issues. Accordingly, improvements in the field are desired.

### Enhanced In-Device Coexistence Reporting in Wireless Communication Systems

One technique for improving a user's experience may involve utilizing frequency division multiplexing (FDM) techniques in IDC scenarios to reduce or mitigate interference issues. For example, a UE may detect an IDC issue related to the usage of certain radio resources and provide this information to the network so that the network may accordingly adjust or restrict radio resource usage via FDM. FDM may be utilized in different ways to more flexibly and efficiently allocate resources and in effect reduce or mitigate interference issues related to IDC of the UE. In other words, by reporting affected or potentially problematic resources due to IDC, the UE may benefit from the network using this information with FDM to avoid said resources. This may help to avoid interference issues that may have resulted from their use and in turn provide a better user experience.

There may be different ways to perform enhanced IDC reporting based on network (NW) control and user equipment (UE) assisted information (e.g., uplink assistance information (UAI)). For example, FDM may be utilized based on the UE receiving a radio resource control (RRC) message and in response to determining an IDC issue or problem concerning radio resources, the UE may provide UAI to the network to inform it of the potentially problematic resources, according to some embodiments. In some embodiments, if the NW applies a FDM method using enhanced IDC reporting via UAI received from the UE, the NW may be able to instruct the UE to perform a handover (HO) procedure to another frequency. Additionally or alternatively, if the UE is in communication with a secondary cell, the NW may be able to de-configure or deactivate the indicated interfered SCell, according to some embodiments.

Additionally or alternatively, methods involving time division multiplexing (TDM) may further correspond to discontinuous reception (DRX) or hybrid automatic repeat request (HARQ) process reservation based scenarios. For example, in some embodiments, a UE may report an interfered frequency and/or suggested TDM pattern to the NW. According to some embodiments, if the NW applies a TDM method based on enhanced IDC reporting via received UAI from the UE, the NW may be able to configure the UE such that it utilizes the suggested DRX configuration. Additionally or alternatively, the NW may be able to perform scheduling based on the UE suggested HARQ reservation pattern, according to some embodiments.

In some embodiments, an enhanced IDC reporting method may be based on the UE performing autonomous denial. For example, the UE may be able to autonomously deny resources (NR or LTE) due to some critical short-term events corresponding to the ISM frequencies (e.g., events during BT/WiFi connection-setup or other important signalling, for example).

Furthermore, existing NR IDC methods may need to be improved such that interference reporting of affected frequencies are adequately indicated. For example, enhancements related to FDM scenarios may allow for more granular indication of affected frequencies (e.g., granularity or specificity at the bandwidth part (BWP) or physical resource block (PRB) level). Moreover, TDM based methods may also be realized through indication of a UE preferred TDM pattern for UL/DL as well as specified RRM requirements or parameters.

Accordingly, to address possible interference issues between 3GPP (including various MR-DC architectures such as NR-DC and EN-DC) and non-3GPP RAT (e.g., WiFi), it may be beneficial for the UE to inform the NW of potential IDC issues concerning certain radio resources. For example, in some scenarios, the UE may detect an internal issue or the possibility of an internal issue caused by in-device coexistence related to usage of certain radio resources. Accordingly in some embodiments, if the UE cannot resolve these issues by itself, the UE may provide information to the NW (e.g., gNB) to assist the NW in restricting specified radio resource usage so as to avoid the UE internal issue (or potential issue) caused by coexistence.

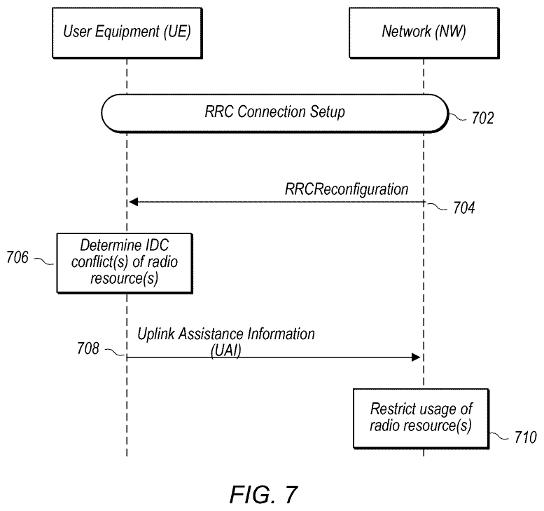

### FIG. 7—Method for Enhanced IDC Reporting

FIG. 7 is a communication flow diagram illustrating example aspects of a method for enhanced IDC reporting, at least according to some embodiments.

Aspects of the method of FIG. 7 may be implemented by a wireless device 106 (such as a UE 106 illustrated in various of the Figures herein), network (e.g., which may be provided by one or more base stations such as a BS 102 illustrated in various of the Figures herein), and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

It should be noted that while the techniques of FIG. 7 are described primarily in conjunction with enhanced IDC reporting, various of the techniques described herein may also or alternatively be applicable in any of various other scenarios which may be further defined or described in appropriate 3GPP specifications and standards.

In various embodiments, some of the elements of the methods shown may be performed concurrently, in a different order than shown, may be substituted for by other method elements, or may be omitted. Additional elements may also be performed as desired. As shown, the method of FIG. 7 may operate as follows.

In 702, the UE may establish a radio resource control (RRC) connection with a network node through an RRC connection setup procedure, according to some embodiments. For example, the UE may establish communication with a cellular network, e.g., via a wireless link(s) with one or more base stations (102), according to some embodiments. The communication may include a cellular link according to a wireless standard such as 5G NR and/or 6G. For example, the wireless device may establish a session with an AMF entity of the cellular network by way of one or more base stations that provide radio access to the cellular network. Other types of cellular links are also possible, and the cellular network may also or alternatively operate according to another cellular communication technology (e.g., LTE, UMTS, CDMA2000, GSM, etc.), according to various embodiments.

Establishing the RRC connection may include configuring various parameters for communication between the wireless device (e.g., the UE) and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least in some instances, establishing the wireless link(s) may include the wireless device providing capability information for the wireless device. Such capability information may include information relating to any of a variety of types of wireless device capabilities.

In 704, the UE may receive, from the network node, a RRC reconfiguration message, according to some embodiments. For example, the UE may receive a RRC reconfiguration message as part of or in addition to the RRC connection setup procedure in 702. Additionally, the RRC Reconfiguration messages may provide and/or include complete or partial configurations for primary cells (PCells) or secondary cells (SCells) in addition to other RRC configuration information. Moreover, the corresponding operations and RRC messages such as the RRC connection setup in 702 and the RRC reconfiguration in 704 may be further defined or described in appropriate 3GPP specifications and standards. According to some embodiments, the RRC reconfiguration message may include configuration information corresponding to at least one of carrier aggregation, dual-connectivity, one or more BWPs, and/or an absolute radio frequency channel number (ARFCN) configured by the network node. In some embodiments, these examples may include applying or comparing time and frequency resource configurations in different ways. According to some embodiments, the RRC reconfiguration message may include an Otherconfig parameter. For example, according to some embodiments, the NW may be able to configure a maximum denial possibility through a configuration of a parameter Otherconfig.

In 706, the UE may determine one or more conflicts corresponding to in-device coexistence (IDC) of one or more resources, according to some embodiments. For example, the UE may determine, based on the configuration information provided in the RRC reconfiguration message, that certain resources are not suitable (e.g., due to in-device coexistence) to use for future communications or other operations. In other words, the UE may become aware of problematic resources (e.g., one or more conflicts) due to IDC related issues concerning the configurations of the resources and the PCell(s) and/or SCell(s). For example, as one possible scenario, the configured resources may be determined to be non-compatible to use the configured PCell(s) and/or SCell(s) for communications or other operations. According to some embodiments, the UE may have received configuration information in the RRC reconfiguration message corresponding to AutonomousDenial configurations, inter-modulation (IMD) issues corresponding to UL CA, IDC configuration(s) for hardware sharing, or IDC configurations for EN-DC. Accordingly, the UE may be able to determine IDC conflicts of resources based on these configurations or IMD issues which are described in the additional information section below. For example, the UE may be able to determine and indicate through configuration information including certain parameters (hardwareSharingProblem-r13, for example) that certain IDC problems or resource conflicts may occur, according to some embodiments.

According to some embodiments, IDC resource conflicts may be determined based on comparing frequencies of non-cellular (e.g., BT, Wi-Fi) resources to the frequencies of cellular (3GPP defined) resources. Accordingly, resource conflicts or resource contention may occur where the non-cellular and cellular frequencies overlap. Accordingly, determining one or more IDC resource conflicts may include determining cellular frequencies, determining non-cellular frequencies, and comparing them to determine overlap and/or conflicts, according to some embodiments.

In some embodiments, the IDC resource conflicts may be determined based on time domain comparison. For example, the UE may be able to compare time domain parameters of non-cellular resources to the time domain parameters of cellular resources and further determine any contention or overlap between the two. Accordingly, determining one or more IDC resource conflicts may include determining resource based cellular time domain parameters, non-cellular time domain parameters, and comparing them to determine overlap and/or conflicts, according to some embodiments.

In 708, the UE may transmit uplink assistance information (UAI) to the network node, according to some embodiments. The UAI may include information corresponding to the one or more resources and the IDC conflict(s). More specifically, if the UE detects an IDC issue as in 706 corresponding to certain determined radio resources, the UE may provide this information to the network so that the network may accordingly adjust or restrict (e.g., limit, prohibit, deactivate, or release) potentially problematic radio resource usage. According to some embodiments, the UAI may include or be included as a part of a InDeviceCoexIndication message. Additionally or alternatively, the InDeviceCoexIndication message may include certain parameters (hardwareSharingProblem-r13, for example) or assistance information (mrdc-AssistanceInfo-r15, for example) which may be used to indicate to the network certain IDC problems or assistance information, according to some embodiments. According to some embodiments, the UAI may be transmitted as part of RRC, medium access control (MAC) signaling, physical uplink control channel (PDCCH), or physical uplink shared channel signaling.

According to some embodiments, the information corresponding to at least one of the one or more resources and/or the at least one IDC conflict may correspond to one or more bandwidth parts (BWPs) of one or more serving cells, one or more physical resource blocks (PRBs) of one or more serving cells, or an absolute radio frequency channel number (ARFCN) configured by the network node. In other words, the UAI may include information regarding certain BWPs, PRBs or ARFCN(s) that may be usable by the network node in performing operations to restrict (e.g., deactivate, release, limit, prohibit), due to IDC issues, the usage of problematic resources. Additionally or alternatively, the UAI may be transmitted various nodes or network nodes corresponding to different radio access technologies. In other words and in various scenarios involving multiple or different RATs as well as different MN and SN configurations, it may be beneficial for the UAI to be provided to other network entities so that they may also perform resource restriction procedures (e.g., deactivation, deconfiguration, or release of resources), if necessary. For example, perform resource restriction procedures may include at least one of the network performing scheduling based on a hybrid automatic repeat request pattern, configuring the UE to utilize a time domain multiplexing (TDM) pattern, or configuring the UE to utilize a discontinuous reception (DRX) configuration.

In some embodiments, the UAI may include information corresponding to at least one clean or non-clean bandwidth parts (BWPs) or at least one clean or non-clean physical resource blocks (PRBs). Additionally or alternatively, the at least one clean or non-clean BWPs or at least one clean or non-clean PRBs may correspond to one or more component carriers (CCs). In other words, the UAI may include information regarding clean (e.g., non-conflicted or non-problematic) resources or non-clean (conflicted or problematic) resources usable by the network to restrict, limit, or prohibit the usage of non-clean resources. Additionally or alternatively, the UAI may be received via media access control-control element (MAC-CE) signaling, according to some embodiments.

According to some embodiments, the UAI may include an indication of clean and/or non-clean resources in which the clean resources correspond to resources which are not associated with a conflict and the non-clean resources are associated with one or more conflicts. Additionally or alternatively, the UAI may include an indication of the conflicts as well as various mappings between the clean and non-clean resources, potential conflicts and their related parameters, and bit fields in the UAI signaling or any combination thereof, according to some embodiments. In some embodiments, the UAI may include an indication of a preferred TDM pattern for UL and/or DL. Accordingly, the NW may be able to configure the UE with a suggested DRX configuration or perform scheduling based on the UE's indicated HARQ reservation pattern, according to some embodiments.

In 710, the NW may, based on the received UAI, restrict (e.g., through deactivation, deconfiguration, or release as some examples) usage of the one or more resources associated with the one or more IDC problems. For example, the base station or network node may use FDM to specifically allocate resources (and/or disregard/avoid the reported problematic ones) to effectively reduce or mitigate the interference issues that may have occurred if the problematic or conflicted resources has been used for subsequent communications or other operations. According to some embodiments, restriction of non-clean resources may correspond to at least one of only using (e.g., transferring or allocating) clean resources on the one or more CCs, deconfiguring/deactivating/releasing non-clean resources or limiting/prohibiting their use, or releasing a secondary cell (SCell) on one of the one or more CCs which is associated with the non-clean resources.

According to some embodiments, the network node may be able to restrict or release non-clean resources in order to avoid usage of conflicted resources. For example, the network may release one or more of the at least one non-clean BWPs or at least one non-clean PRBs on one of the one or more CCs. Additionally or alternatively, the network node may release, based on one or more of the at least one non-clean BWPs or non-clean PRBs, a secondary cell (SCell) on one of the one or more CCs. In some embodiments, the network node may allocate, based on one or more of the at least one clean BWPs or at least one clean PRBs, resources for the one or more CCs. In other words, the network may be able to avoid subsequent communication errors or issues by releasing BWPs, PRBs or secondary cells corresponding to non-clean resources and allocating appropriate resources corresponding to other resources such as any reported clean resources.

In other words, the method presented may allow for the UE to detect internal issues or the possibility of internal issues caused by coexistence related to the usage of certain radio resources. Additionally, in scenarios in which the UE cannot resolve these issues on its own, the UE may seek to provide this information to the network for assistance. Accordingly, the NW may restrict, limit, or prohibit radio resource usage to avoid the UE internal issue (or potential issue) caused by coexistence.

According to some embodiments, the IDC reporting may be provided, transmitted, or forwarded to various nodes or combinations thereof. For example, the IDC reporting may be provided to a master node (MN) only (LTE or NR), a secondary node (SN) only (LTE or NR), a MN and a SN. Additionally or alternatively, the IDC reporting may further include information regarding the direction of the interference (e.g., a parameter such as InterferenceDirection). For example, the InterferenceDirection may allow for the UE (and network) to differentiate or determine which radio access technologies (RATs) are either a victim or aggressor (cause) of interference, according to some embodiments. More specifically, the Interference Direction may be used to indicate a role of interference (e.g., victim or aggressor) of the master node (MN) only (LTE or NR), a secondary node (SN) only (LTE or NR), a MN and a SN a MN and another RAT, a SN and another RAT, a MN, a SN and another RAT, and/or to another RAT only, according to some embodiments.

In some embodiments, a prohibit timer may be used to specify or enable a certain reporting scheme or schedule. For example, according to some embodiments, the NW may be able to configure an IDC reporting prohibit timer to the UE. Once the UE transmits the UAI, the UE may start the prohibit timer (e.g., an IDC reporting timer). Accordingly, when the prohibit timer is running, the UE may not be able to transmit the UAI again, according to some embodiments. In some embodiments, it may be beneficial for the network node to control how often the UE provides UAI by prohibiting the UE from transmitting the UAI while the prohibit timer is running. According to some embodiments, IDC reporting may include transmitting the UAI to the network. For example, an IDC report or IDC reporting message may include or be included as part the UAI, according to some embodiments. Additionally or alternatively, the UAI may include or be included as part an IDC report or IDC reporting message.

It should be noted, however, that the example details illustrated in and described with respect to FIG. 7 are not intended to be limiting to the disclosure as a whole: numerous variations and alternatives to the details provided herein below are possible and should be considered within the scope of the disclosure.

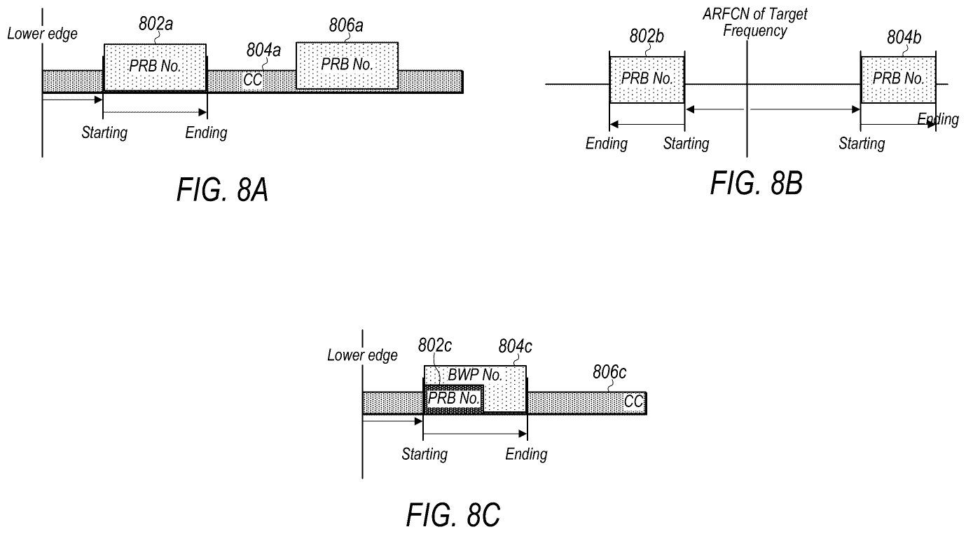

### FIGS. 8A-8C-Enhanced IDC Reporting Using Frequency Division Multiplexing (FDM)

FIGS. 8A-8C are flow diagrams illustrating various aspects and methods for enhanced IDC reporting involving frequency division multiplexing (FDM), according to some embodiments.

In some embodiments, frequency division multiplexing (FDM) may be incorporated by the NW upon receiving UAI including bandwidth part (BWP) reporting from the UE. For example, serving cells and BWP(s) may be configured for the UE and the UE may indicate to the NW about the IDC issue based on a current configured BWP on the serving cell(s). According to some embodiments, FDM may be incorporated by the NW upon receiving UAI including physical resource block (PRB) reporting from the UE. For example, the UE may perform IDC reporting corresponding to PRBs of the serving cells that have been configured for the UE, according to some embodiments. In other scenarios, the UAI including corresponding to the PRBs may be based on target frequency (ARFCN) configured by the network (NW).

In some embodiments, the NW may utilize FDM through IDC reporting corresponding to one or more reported BWPs. In other words, the NW may implement FDM based on UAI from the UE. For example, the UE may report “clean” (e.g., not associated with an IDC problem or issue) downlink or uplink (DL/UL) BWP number(s) or “non-clean” (e.g., associated with an IDC problem or issue) DL/UL BWP number(s). Additionally or alternatively, the UAI may include UL BWP number(s) that indicate that a 3GPP RAT affects or can affect another RAT. In some embodiments, the UAI may include DL (as a possible extension to UL) BWP number(s) which indicate that another RAT affects or can affect a 3GPP RAT.

In some embodiments, the UE may provide UAI to the network based on a configured serving cell and using one or more PRB(s). For example, as shown in FIG. 8A, the UE may report or transmit the UAI including one or more starting points based on the lower edge of the component carrier CC 804a for clean or non-clean resources such as PRB 802a and/or PRB 806a, according to some embodiments. Additionally or alternatively, the UE may report the starting point based on the lower edge of the CC and an ending point for clean or non-clean resources such as PRB 802a and/or PRB 806a. In other words, the UE may provide the network with information necessary for determining which PRBs are considered to be clean or non-clean.

According to some embodiments, the UE may provide UAI to the network based on a target frequency configured by the network. For example, as shown in FIG. 8b, the UE may report (e.g., transmit UAI) including starting and/or ending points of clean or non-clean resources (e.g., PRBs 802b and 804b based on the Absolute Radio Frequency Channel Number (ARFCN) (e.g., target frequency), according to some embodiments. In other words, the UE may provide the network with information necessary for determining which PRBs are considered to be clean or non-clean based on or in relation to a target frequency.

In some embodiments, the UE may be configured to provide mixed UAI to the network on BWPs and PRBs. In other words, it may be possible for the UE to apply both CC based and target frequency-based IDC reporting. Accordingly, the UE may be able to report the clean or non-clean resource(s) at the PRB level for each BWP. For example, as shown in FIG. 8C, the UE may report one or more starting points based on the lower edge of the component carrier CC 806c for clean or non-clean resources such as PRB 802c which may correspond or be included in BWP 804c, according to some embodiments. Additionally or alternatively, the UE may report the starting point of BWP 804c based on the lower edge of the CC 806c and an ending point for the clean or non-clean resources of BWP 804c (which may include PRB 802c). In other words, the UE may provide the network with information necessary for determining which PRBs and/or BWPs are considered to be clean or non-clean. Additionally or alternatively, the BWP number and the PRB resource may be based on the lower edge of the BWP, according to some embodiments.

Note also that the techniques described herein may be applied to either or both of NR and LTE IDC reporting or IDC related UAI techniques, according to various embodiments.

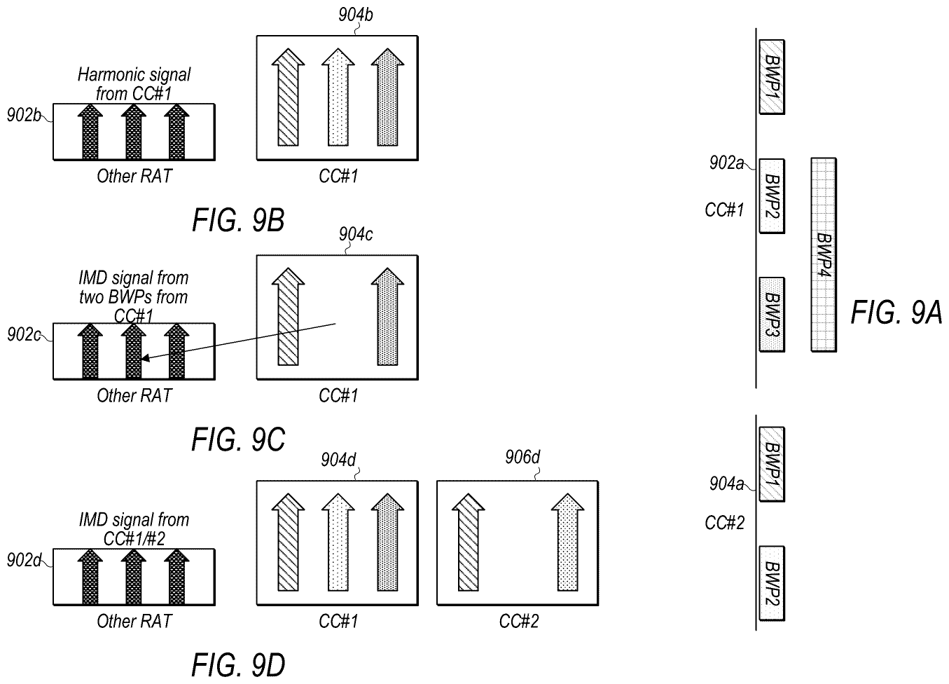

### FIGS. 9A-9D-Enhanced IDC Reporting for Single Carrier Reporting and Carrier Aggregation Reporting

FIGS. 9A-9D illustrate various aspects and methods for enhanced IDC reporting or IDC UAI involving single carrier FDM and carrier aggregation FDM, according to some embodiments. More specifically, FIG. 9A illustrates the BWP configuration of two different component carriers and FIGS. 9B-9D illustrate the harmonic and IMD signals corresponding to the UE's IDC reporting of clean or non-clean resources.

For example, FIG. 9A includes CC #1 902a corresponding to BWP1, BWP2, BWP3, and BWP4, according to some embodiments. Additionally, FIG. 9A illustrates CC #2 904a which may correspond to BWP1 and BWP2. In the scenario of single carrier FDM, the UE may report clean or non-clean resources from a single carrier such as CC #1 902a or CC #2 904a.

Moreover, in some embodiments, the affected resources reporting for a single CC may involve a 3GPP RAT affecting another RAT due to harmonic distortions/interference. Accordingly, the UE may report non-clean or clean BWP(s) to the network through UAI in order to receive assistance from the NW regarding potentially problematic resources (e.g., based on IDC issues). For example, as shown in FIG. 9B, the UE may provide IDC reporting to the network based on the BWPs from CC #1 902a. More specifically, the UE may include in a report 904b (e.g., UAI) certain BWPs such as BWP1, BWP2, and BWP3 from CC #1 902a which further correspond to clean or non-clean resources. Accordingly, the resultant harmonic signal from CC #1 is shown as 902b which affects another RAT due to harmonic distortions/interference due to the IMD reporting, according to some embodiments.

According to some scenarios, a 3GPP RAT may affect another RAT due to intermodulation (IMD) issues from two or more (e.g., multiple) UL BWP(s). Accordingly, the UE may report non-clean or clean BWP(s) from the same CC. In other words, the UE may be able to choose how to report clean or non-clean resources and indicate them to the NW. For example, as shown in FIG. 9C, the UE may provide IDC reporting to the network based on the BWPs from CC #1 902a. More specifically, the UE may include in a report 904c (e.g., UAI) certain BWPs such as BWP1 and BWP3 from CC #1 902a which further correspond to clean or non-clean resources. Accordingly, the resultant IMD signal from two BWPs from CC #1 is shown as 902c which may affect another RAT due to intermodulation (IMD) distortions/interference from the IDC reporting, according to some embodiments.

According to some embodiments, affected resources reporting for CA may involve a 3GPP RAT affecting another RAT due to an IMD issue. As one option, the UE may report the non-clean resources (e.g., UL resources on two or multiple CC(s)) which would interfere with the other RAT, according to some embodiments. However, those resources may lead to IMD interference to other RATs (e.g., CC #1 UL BWP1 and CC #2 UL BWP 2 or CC #1 UL PRB resource and CC #2 UL BWP 2) as shown in FIG. 9D. More specifically, FIG. 9D illustrates how the UE may perform IDC reporting to the network based on BWPs from two CCs (e.g., CC #1 902a and CC #2 904a). For example, the UE may the UE may provide IDC reporting to the network based on the BWPs from CC #1 in 904d and from CC #2 in 906d. More specifically, the UE may include in a report 904d (e.g., UAI) certain BWPs such as BWP1, BWP2, and BWP3 from CC #1 902a which further correspond to clean or non-clean resources from CC #1. Additionally or alternatively, the UE may include in a report 906d (e.g., UAI) certain BWPs such as BWP1 and BWP3 from CC #2 904a which further correspond to clean or non-clean resources from CC #2. Accordingly, the resultant IMD signal from CC #1 and CC #2 is shown as 902d which may affect another RAT due to the IMD distortions/interference related to the IDC reporting, according to some embodiments.

Moreover, this IMD interference may not be limited to just two CCs, according to some scenarios. Accordingly, the NW handling may involve not using (e.g., restricting, limiting, or prohibiting) the resource pair simultaneously and further releasing the problematic UL BWP(s) on one CC or releasing the secondary cell (SCell), according to some embodiments. As a second option the UE may report the clean resources. For example, the UE may report the resources on multiple CC(s) which do not interfere with another RAT. Accordingly, the NW handling may involve making sure the clean BWP combinations are used on the multiple CC(s), according to some embodiments.

In some embodiments, the UE may be able to utilize FDM in a CA scenario by reporting the affected resources due to a 3GPP RAT affecting (or may affect) another RAT due to one or more harmonic issues. Accordingly, the UE may report the clean or non-clean resource set corresponding to UL BWP(s) or PRB resources and the NW handling may involve not using the non-clean UL BWP(s) or PRB resources. According to another scenario in which another RAT affects (or is affecting) a 3GPP RAT, the UE may report the non-clean resources such that the affected DL BWP(s) are reported on each affected CC(s) or the PRB resources affected are reported, according to some embodiments. Additionally or alternatively, the UE may report the clean resources such that the clean DL BWP(s) on each CC are reported or the clean PRB resources are reported. Accordingly, the NW handling may involve only making the clean DL BWP(s) as active BWP(s). Additionally or alternatively, the NW may opt to release the non-clean BWP(s), according to some embodiments. Furthermore, a parameter included in the UAI such as Interference Direction may be used to differentiate between the scenarios described above in which the 3GPP RAT affects another RAT due to harmonic or IMD issues (e.g., distortions/interference) or another RAT affects the 3GPP RAT, according to some embodiments.

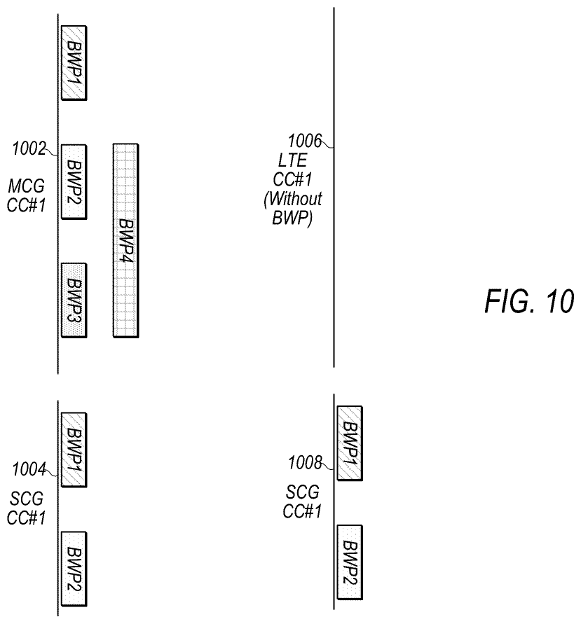

### FIG. 10—Enhanced IDC Reporting for Multi-RAT Dual Connectivity

FIG. 10 illustrates an example configuration of component carriers for enhanced IDC reporting for multi-radio access technology-dual connectivity (MR-DC), according to some embodiments. More specifically, FIG. 10 includes a master cell group (MCG) of CC #1 1002 corresponding to BWP1, BWP2, BWP3, and BWP4, according to some embodiments. Additionally, FIG. 10 illustrates a secondary cell group (SCG) of CC #1 1004 which may correspond to BWP1 and BWP2. In MR-DC, the UE may also be connected to another RAT LTE CC #1 1006 which may not include any BWPs. However, SCG of CC #1 1008 may include BWP1 and BWP2, according to some scenarios.

In some embodiments, affected resources reporting for MR-DC scenarios for IMD may result due to issues from two cell groups or legs (e.g., two UL BWPs/PRBs on two cell groups or legs). However, the UE IDC reporting may be approached in a similar way as in CA. For example, a master node (MN) may configure IDC to the UE and the UE may report the IDC information back to the MN, according to some embodiments. Additionally or alternatively, there may be coordination between the MN and a secondary node (SN). In some embodiments, the network node may receive, from, a secondary cell group (SCG) configuration for carrier aggregation (CA). Additionally or alternatively, the network node may receive, from the SN, at least one bandwidth part (BWP) or absolute radio frequency channel number (ARFCN). In some embodiments, the network may forward the UAI to SN. In other words, the SN may provide the MN with a SCG configuration on CA and BWP or a target frequency for IDC reporting, according to some embodiments. Additionally or alternatively, the MN may provide or forward the IDC assistance information (reported by the UE) to the SN. Accordingly, static NW handling may involve the actual BWP(s), SCell(s), or PRB(s) being used in one cell group (CG), according to some embodiments.

In some embodiments, it may be beneficial for one node (e.g., an SN) to be restricted, limited, or prohibited such that it is not able to configure the BWP/SCell(s)/PRB(s) corresponding to the problematic resource combination. Additionally or alternatively, the other node (e.g, the MN) may be able to use the other resource in the problematic resource pair, according to some embodiments. Furthermore, both nodes (e.g., the MN and SN) may be able to reconfigure the BWP(s)/SCell(s)/PRB(s) to make sure only clean resources are configured. For example, in a Xn exchange (e.g., via an Xn interface), one node may reconfigure its BWP(s)/SCell(s)/PRB(s) and inform the other node about the update, according to some embodiments. Additionally or alternatively, a Xn exchange may involve the MN informing the SN which BWP(s)/SCell(s)/PRB(s) to use (or not to use), according to some embodiments.

According to some embodiments, dynamic NW handling may correspond to the NW exchanging the BWP(s)/SCell(s)/PRB(s) at use with each other in addition to the static exchange mentioned above. Additionally or alternatively, the UE may transmit the assistance information to the NW when BWP switching/SCell addition/release/deactivation/activation occurs, according to some embodiments.

In some embodiments, affected resources reporting for a MR-DC may include scenarios involving harmonic (one UL) interference and IMD interference coming from one cell group or leg (two UL on one cell group or leg). Accordingly, the UE reporting content may be approached similarly as done for CA. However, in some embodiments, it may be beneficial to perform independent NW handling procedures. For example, either the MN or SN may be able to configure the IDC to the UE independently, according to some embodiments. Accordingly, there may not be any coordination (related to IDC reporting) between the MN and the SN. In other words, the MCG or SCG may configure the UE for IDC reporting such that the UE reports the IDC information directly to the MN or SN, according to some embodiments.

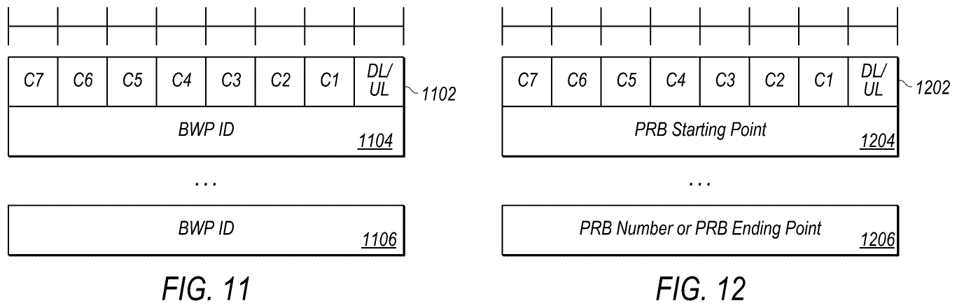

### FIGS. 11-12-Enhanced IDC Reporting Using MAC-CE

According to some embodiments, the UE may apply FDM based on IDC reporting through utilization of medium access control-control elements (MAC-CE). In other words, alternative to some of the FDM methods described above in which the UE may use radio resource control (RRC) messages for IDC reporting, the UE may also be able or configured to utilize MAC-CE to report the IDC problem or resources associated with IDC issues.

For example, FIG. 11 illustrates an example MAC-CE structure of how multiple BWP IDs 1104 and 1106 may be reported (e.g., as clean or non-clean resources) in relation to the fields of octet 1102 which includes C1-C7 and an UL/DL field. In other words, the octet 1102 may be used to report BWP IDs 1104 and 1106 using mappings between the UL/DL and C1-C7 fields and the BWP IDs 1104 and 1106, according to some embodiments.

As another example, FIG. 12 illustrates an example MAC-CE structure of how PRB Starting Points, PRB Numbers, or PRB Ending points may be reported or indicated (e.g., as clean or non-clean resources) in relation to the fields of octet 1202 which includes C1-C7 and an UL/DL field. In other words, the octet 1202 may be used to report or indicate a PRB Starting Point such as 1204 and a PRB Number or PRB Ending Point such as 1206 using mappings between the UL/DL and C1-C7 fields and the 1204 and 1206, according to some embodiments.

Moreover, BWP based reporting through MAC-CE may be an option as the BWP configuration may have already been provided to UE. Accordingly, the UE may be able to report the non-clean or clean resources via MAC-CE using BWP or PRBs once an IDC problem is detected.

### Additional Information

According to some embodiments, the NW may be able to configure a maximum denial possibility. For example, the NW may configure a maximum denial number through a configuration of a parameter Otherconfig. For example, the Otherconfig parameter may include a first portion of a code block including:

IDC-Config-r11 ::= SEQUENCE {
idc-Indication-r11 ENUMERATED {setup} OPTION, -- Need OR

Additionally, the Otherconfig parameter may include a second portion of a code block corresponding to an AutonomousDenial configuration including:

| | autonomousDenialParameters-r11 SEQUENCE{ | | |
|---|---|---|---|
| | | autonomousDenialSubframes-r11 | ENUMERATED {n2, n5, n10, n15, n20, n30, |
| spare2, spare1}, | | | |
| | | autonomousDenialValidity-r11 | ENUMERATED {sf200, sf500, sf1000, |

sf2000, spare4, spare 3, spare 2, spare1}

| } | OPTIONAL, -- Need OR |
|---|---|
| ..., | |

Additionally, the Otherconfig parameter may include a third portion of a code block corresponding to an IMD issue due to UL CA including:

[[ idc-Indication-UL-CA-r11 ENUMERATED {setup} OPTIONAL - Cond idc-Ind
]],

Additionally, the Otherconfig parameter may include a fourth portion of a code block corresponding to an IDC configuration for hardware sharing including:

[[ idc-HardwareSharingIndication-r13 ENUMERATED {setup} OPTIONAL - Need
OR
]],

Additionally, the Otherconfig parameter may include a fifth portion of a code block corresponding to an IDC configuration for EN-DC including:

| [[ idc-Indication-MRDC-r15 | | | CHOICE{ |
|---|---|---|---|
| release | | NULL, | |
| setup | | | CandidateServingFreqListNR-r15 |
| } | OPTIONAL -- Cond idc-Ind | | |
| ]] | | | |
| } | | | |

Additionally or alternatively, the UE reporting (e.g., IDC reporting, UAI) may include or be included in a InDeviceCoexIndication message. For example, a InDeviceCoexIndication message may include a first portion of a code block including:

| IndeviceCoexIndication-r11-IEs | ::=SEQUENCE { | | | |
|---|---|---|---|---|
| affectedCarrierFreqList-r11 | | AffectedCarrierFreqList-r11 | | |
| OPTIONAL, | | | | |
| tdm-AssistanceInfo-r11 | TDM-AssistanceInfo-r11 | | OPTIONAL, | |
| lateNonCriticalExtension | OCTET STRING | | OPTIONAL, | |
| nonCriticalExtension | InDeviceCoexIndication-v11d0-IEs | | | OPTIONAL |
| } | | | | |

IndeviceCoexIndication-v11d0IEs --= SEQUENCE {
u1-CA-AssistanceInfo-r11 SEQUENCE {

| affectedCarrierFreqCombList-r11 | | | affectedCarrierFreqCombList-r11 | | |
|---|---|---|---|---|---|
| OPTIONAL, | | | | | |
| victimSystemType-r11 | | | victimSystemType-r11 | | |
| } | | | | OPTIONAL, | |
| nonCriticalExtension | InDeviceCoexIndication-v1310-IEs | | | | |
| OPTIONAL | | | | | |
| } | | | | | |
| IndeviceCoexIndication-v1310-IEs | ::= SEQUENCE { | | | | |
| affectedCarrierFreqList-v1310 | | AffectedCarrierFreqList-v1310 OPTIONAL, | | | |
| affectedCarrierFreqCombList-r13 | | AffectedCarrierFreqCombList-r13 | | | OPTIONAL, |
| NonCriticalExtension | | IndeviceCoexIndication-v1360-IEs | | | OPTIONAL |
| } | | | | | |

Additionally. VictimSystemType-r11 may include:

| | | |
|---|---|---|
| VictimSystemType | ::= SEQUENCE { | |
| gps-r11 | ENUMERATED {true} | OPTIONAL, |
| glonass-r11 | ENUMERATED {true} | OPTIONAL, |
| gps-r11 | ENUMERATED {true} | OPTIONAL, |
| bds-r11 | ENUMERATED {true} | OPTIONAL, |
| galileo-r11 | ENUMERATED {true} | OPTIONAL, |
| wlan-r11 | ENUMERATED {true} | OPTIONAL, |
| bluetooth-r11 | ENUMERATED {true} | OPTIONAL |
| } | | |

Additionally. TDM-AssistanceInfo-r11 may include:

| | | |
|---|---|---|
| TDM-AssistanceInfo-r11 | ::= | CHOICE { |

| | |
|---|---|
| drx-AssistanceInfo-r11 | SEQUENCE { |

| | |
|---|---|
| drx-CycleLength-r11 | ENUMERATED {sf40, sf64, sf80, sf128, |

sf160, sf256, spare2, spare1},

| | |
|---|---|
| drx-Offset-r11 | INTEGER (0..255) OPTIONAL, |
| drx-ActiveTime-r11 | ENUMERATED (sf20, sf30, sf60, sf80, |

sf100, spare2, spare 1},

| }, | |
|---|---|
| Idc-SubframePatternList-r11 | IDC-SubframePatternList-r11, |
| ... | |
| } | |

| | |
|---|---|
| IDC-SubframePatternList-r11 | ::= SEQUENCE (SIZE(1..maxSubframePatternIDC-r11)) |

OF IDC-SubframePattern-r11

| IDC-SubframePattern-r11 | ::= CHOICE { | | |
|---|---|---|---|
| subframePatternFDD-r11 | | BIT STRING (SIZE(4)), | |
| subframePatternTDD-r11 | | CHOICE { | |
| subframeConfig0-r11 | | | BIT STRING (SIZE (70)), |
| subframe1-5-r11 | | | BIT STRING (SIZE (10)), |
| subframeConfig6-r11 | | | BIT STRING (SIZE (60)) |
| }, | | | |
| ... | | | |
| } | | | |

Additionally, a InDeviceCoexIndication message may include a first portion of a code block related to hardware sharing including:

| InDeviceCoexIndication-v1360-IEs ::= | SEQUENCE { | |
|---|---|---|
| hardwareSharingProblem-r13 | ENUMERATED {true} | OPTIONAL, |
| nonCriticalExtension | InDeviceCoexIndication-v1530-IEs, OPTIONAL | |
| } | | |

Additionally, a InDeviceCoexindication message may include a second portion of a code block related to EN-DC including:

| | | |
|---|---|---|
| IndeviceCoexIndication-v1530-IEs ::= | SEQUENCE { | |
| mrdc-AssistanceInfo-r15 | MRDC-AssistanceInfo-r15 | OPTIONAL, |
| nonCriticalExtension | SEQUENCE { } | OPTIONAL |
| } | | |

Additionally, a InDeviceCoexindication message may include a third portion of a code block including:

| | |
|---|---|
| MRDC-AssistanceInfo-r15 ::= | SEQUENCE { |

| | |
|---|---|
| affectedCarrierFreqCombInfoListMRDC-r15 | SEQUENCE (SIZE |

(1..maxCombIDC-r11)) OF Affected CarrierFreqCombInfoMRDC-r15,

...
}

| | |
|---|---|
| AffectedCarrierFreqCombInfoMRDC-r15 | ::= SEQUENCE { |

| | |
|---|---|
| victimSystemType-r15 | victimSystemType-r11 |

| | |
|---|---|
| interferenceDirectionMRDC-r15 | ENUMERATED {eutra-nr, nr, other, eutra-nr-other, |

nr-other, spare3, spare2, spare1},

| affectedCarrierFreqCombMRDC-r15 | | | SEQUENCE { | |
|---|---|---|---|---|
| affectedCarrierFreqCombEUTRA-r15 | | | | AffectedCarrierFreqComb-r15 |
| OPTIONAL, | | | | |
| affectedCarrierFreqCombNR-r15 | | | | AffectedCarrierFreqCombNR-r15 |
| } | OPTIONAL | | | |
| } | | | | |
| AffectedCarrierFreqComb-r15 | | ::= SEQUENCE (SIZE (1..maxServCell-r13)) OF | | |
| MeasObjectId-r13 | | | | |
| AffectedCarrierFreqCombNR-r15 | | ::= SEQUENCE (SIZE (1..maxServCellNR-r15)) OF | | |
| ARFCN-ValueNR-r15 | | | | |

Additionally, a affectedCarrierFreqCombList parameter may indicate a list of E-UTRA carrier frequencies that may be affected by IDC problems due to Inter-Modulation Distortion and harmonics from E-UTRA when configured with UL CA, according to some embodiments. In some embodiments, affectedCarrierFreqCombList-r13 may be used when more than five serving cells are configured or affected combinations contain MeasObjectId larger than 32. Additionally or alternatively, if affectedCarrierFreqCombList-r13 is included, affectedCarrierFreqCombList-r11 may not be included.

In some embodiments, a affectedCarrierFreqCombMRDC parameter may indicate a set of at least one NR carrier frequency and optionally one or more E-UTRA carrier frequencies that are affected by IDC problems due to inter-modulation distortion and harmonics when configured with MR-DC.

Still another example embodiment may include a device, comprising: an antenna; a radio coupled to the antenna; and a processing element operably coupled to the radio, wherein the device is configured to implement any or all parts of the preceding examples.

Yet another example embodiment may include a method, comprising: by a device: performing any or all parts of the preceding examples.

A further exemplary embodiment may include a non-transitory computer accessible memory medium comprising program instructions which, when executed at a device, cause the device to implement any or all parts of any of the preceding examples.

A still further example embodiment may include a computer program comprising instructions for performing any or all parts of any of the preceding examples.

A yet further example embodiment may include an apparatus comprising means for performing any or all of the elements of any of the preceding examples.

Still another example embodiment may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106 or BS 102) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
receiving, from a network node, a radio resource control (RRC) reconfiguration message;
determining, based on the RRC reconfiguration message, at least one of one or more clean resources or one or more non-clean resources, wherein the one or more non-clean resources correspond to at least one in-device coexistence (IDC) conflict; and
transmitting uplink assistance information (UAI) to the network node, wherein the UAI comprises information corresponding to one or more starting points and one or more ending points of at least one of the one or more clean resources or one or more non-clean resources.

2. The method of claim 1, wherein the information includes one or more resource numbers of the one or more clean resources and the one or more non-clean resources, and wherein at least one of the one or more starting points or one or more ending points are reported by a user equipment (UE) in relation to at least one of a lower edge of a component carrier (CC) or an absolute radio frequency channel number (ARFCN).

3. The method of claim 1, wherein the one or more clean resources and one or more non-clean resources are at least one of one or more bandwidth parts (BWPs) or one or more physical resource blocks (PRBs).

4. The method of claim 1, wherein the RRC reconfiguration message includes configuration information corresponding to at least one of:
carrier aggregation;
dual-connectivity;
one or more BWPs; or
an absolute radio frequency channel number (ARFCN) configured by the network node.

5. The method of claim 1, wherein the network node comprises a master node (MN) corresponding to a first radio access technology (RAT), and wherein the UAI is transmitted to at least one of:
the MN; or
a secondary node (SN) corresponding to the first RAT.

6. The method of claim 1, further comprising:
receiving, from the network node, configuration information corresponding to an IDC reporting prohibit timer.

7. The method of claim 6, further comprising:
starting the IDC reporting prohibit timer after transmitting the UAI, wherein a user equipment (UE) is prohibited from transmitting additional UAI while the IDC reporting prohibit timer is running.

8. A method, comprising:
transmitting, to a user equipment (UE), a radio resource control (RRC) reconfiguration message;
receiving, from the UE, uplink assistance information (UAI), wherein the UAI comprises information corresponding to at least one of one or more clean resources or one or more non-clean resources associated with one or more component carriers (CCs), and wherein the one or more non-clean resources correspond to at least one in-device coexistence (IDC) conflict; and
restricting, based on the UAI, usage of the one or more non-clean resources.

9. The method of claim 8, wherein the UAI comprises information corresponding to at least one of one or more starting points or one or more ending points of at least one of the one or more clean resources or one or more non-clean resources.

10. The method of claim 8, wherein the one or more clean resources and one or more non-clean resources are at least one of one or more bandwidth parts (BWPs) or one or more physical resource blocks (PRBs).

11. The method of claim 8, wherein the RRC reconfiguration message includes configuration information corresponding to at least one of:
carrier aggregation;
dual-connectivity;
one or more BWPs; or
an absolute radio frequency channel number (ARFCN) configured by a network node.

12. The method of claim 8, wherein restricting usage of the one or more non-clean resources comprises releasing one or more of the non-clean resources.

13. The method of claim 8, wherein restricting usage of the one or more non-clean resources comprises releasing a secondary cell (SCell) on one of the one or more CCs.

14. The method of claim 8, wherein restricting usage of the one or more non-clean resources comprises at least one of:
performing scheduling based on a hybrid automatic repeat request pattern;
configuring the UE to utilize a time domain multiplexing (TDM) pattern; or
configuring the UE to utilize a discontinuous reception (DRX) configuration.

15. The method of claim 8, further comprising:
receiving, from a secondary node (SN), a secondary cell group (SCG) configuration for carrier aggregation (CA); and
forwarding the UAI to the SN.

16. The method of claim 8, further comprising:
transmitting, to the UE, configuration information corresponding to an IDC reporting prohibit timer, wherein the UE is prohibited from transmitting additional UAI while the IDC reporting prohibit timer is running.

17. The method of claim 8, wherein the UAI is received via media access control control element (MAC-CE) signaling.

18-20. (canceled)

21. An apparatus, comprising:
a processor configured to, when executing instructions stored in a memory, perform operations comprising:
establishing a radio resource control (RRC) connection with a network node;
receiving, from the a network node, a radio resource control (RRC) reconfiguration message;
determining, based on the RRC reconfiguration message, at least one of one or more clean resources or one or more non-clean resources, wherein the one or more non-clean resources correspond to at least one in-device coexistence (IDC) conflict; and
transmitting uplink assistance information (UAI) to the network node, wherein the UAI comprises information corresponding to one or more starting points and one or more ending points of at least one of the one or more clean resources or one or more non-clean resources.

22. The apparatus of claim 21, wherein the information includes one or more resource numbers of the one or more clean resources and the one or more non-clean resources, and wherein at least one of the one or more starting points or one or more ending points are reported by a user equipment (UE) in relation to at least one of a lower edge of a component carrier (CC) or an absolute radio frequency channel number (ARFCN).

23. The apparatus of claim 21, wherein the one or more clean resources and one or more non-clean resources are at least one of one or more bandwidth parts (BWPs) or one or more physical resource blocks (PRBs).
